(19) United States
(12) Patent Application Publication
(10) Pub. No.: US 2022/0075785 A1
(43) Pub. Date: Mar. 10, 2022

(54) COMPUTER-READABLE RECORDING MEDIUM STORING DATA PROCESSING PROGRAM, DATA PROCESSING DEVICE, AND DATA PROCESSING METHOD

(71) Applicant: FUJITSU LIMITED, Kawasaki-shi (JP)

(72) Inventors: Yiyue Jiang, Kawasaki (JP); Yoshiyuki Sakamaki, Kawasaki (JP); Kenji Hikichi, Kawasaki (JP)

(73) Assignee: FUJITSU LIMITED, Kawasaki-shi (JP)

(21) Appl. No.: 17/337,506

(22) Filed: Jun. 3, 2021

(30) Foreign Application Priority Data
Sep. 9, 2020 (JP) 2020-151011

(51) Int. Cl. G06F 16/2455; G06F 16/21; G06F 16/22; G06F 16/28

(52) U.S. Cl. CPC G06F 16/24558; G06F 16/288; G06F 16/2282; G06F 16/213

(57) ABSTRACT

A non-transitory computer-readable recording medium stores a data processing program for causing a computer to execute processing including: obtaining a similarity between each of a plurality of attributes included in first table data and each of a plurality of attributes included in second table data; and associating each of the plurality of attributes included in the first table data with any attribute of the plurality of attributes included in the second table data on the basis of the similarity, an order of the plurality of attributes included in the first table data, and an order of the plurality of attributes included in the second table data.

### CROSS-REFERENCE TO RELATED APPLICATION

This application is based upon and claims the benefit of priority of the prior Japanese Patent Application No. 2020-151011, filed on Sep. 9, 2020, the entire contents of which are incorporated herein by reference.

### FIELD

The embodiment discussed herein is related to data processing.

### BACKGROUND

Table data such as a relational database (RDB) is used in data analysis or machine learning. The table data often includes an attribute value for each of a plurality of attributes. An attribute included in the table data is sometimes called a column or an item.

Japanese Laid-open Patent Publication No. 2020-112919, International Publication Pamphlet No. WO 2016/125277, Japanese Laid-open Patent Publication No. 2012-38066, and F. Nargesian et al., “Table Union Search on Open Data”, Proceedings of the VLDB Endowment, Vol. 11, No. 7, March 2018, pages 813-825 are disclosed as related art.

### SUMMARY

According to an aspect of the embodiments, a non-transitory computer-readable recording medium stores a data processing program for causing a computer to execute processing including: obtaining a similarity between each of a plurality of attributes included in first table data and each of a plurality of attributes included in second table data; and associating each of the plurality of attributes included in the first table data with any attribute of the plurality of attributes included in the second table data on the basis of the similarity, an order of the plurality of attributes included in the first table data, and an order of the plurality of attributes included in the second table data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating combining processing;

FIG. 2 is a diagram illustrating incorrect association;

FIG. 3 is a functional configuration diagram of a data processing device;

FIG. 4 is a flowchart of data processing;

FIG. 5 is a functional configuration diagram illustrating a first specific example of the data processing device;

FIG. 6 is a diagram illustrating similarity information;

FIG. 7 is a diagram illustrating association processing using an attribute adjacent to a left side of an association candidate attribute;

FIG. 8 is a diagram illustrating association processing using an attribute adjacent to a right side of an association candidate attribute;

FIG. 9 is a flowchart of first association processing;

FIG. 10 is a diagram illustrating association processing using attributes adjacent to both sides of an association candidate attribute;

FIG. 11 is a flowchart of second association processing;

FIG. 12 is a functional configuration diagram illustrating a second specific example of the data processing device;

FIG. 13 is a diagram illustrating association processing using weight information;

FIG. 14 is a flowchart of third association processing;

FIG. 15 is a functional configuration diagram illustrating a third specific example of the data processing device; and

FIG. 16 is a hardware configuration diagram of the information processing device.

### DESCRIPTION OF EMBODIMENTS

In combining processing of combining two table data to generate integrated table data, attributes are associated on a one-to-one basis between the two table data.

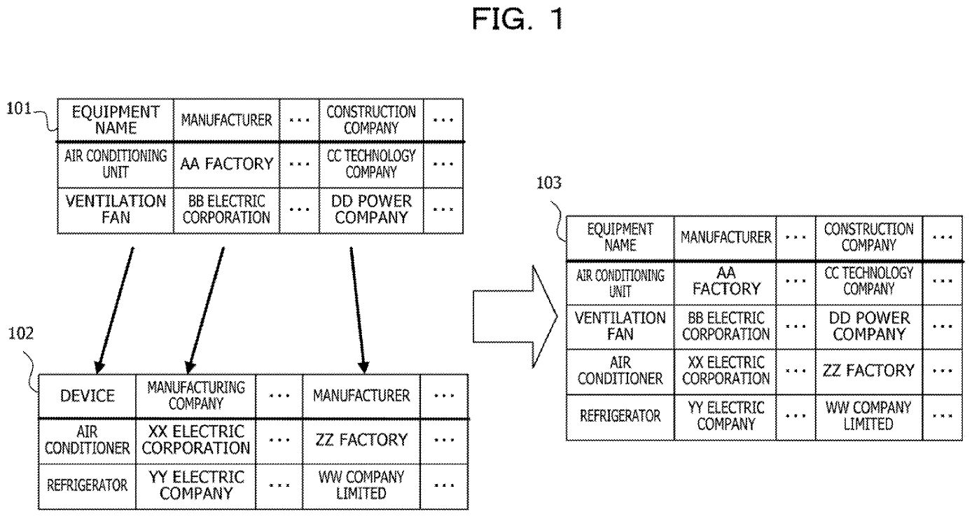

FIG. 1 illustrates an example of the combining processing. Table data 101 includes attributes such as “equipment name”, “manufacturer”, and “construction company”, and includes a plurality of attribute values of each of the attributes. “Air conditioning unit” and “ventilation fan” are the attribute values of the “equipment name”, “AA factory” and “BB electric corporation” are the attribute values of the “manufacturer”, and “CC technology company” and “DD power company” are the attribute values of the “construction company”.

Table data 102 includes attributes such as “device”, “manufacturing company”, and “construction company”, and includes a plurality of attribute values of each of the attributes. “Air conditioner” and “refrigerator” are the attribute values of the “device”, “XX electric corporation” and “YY electric company” are the attribute values of the “manufacturing company”, and “ZZ factory” and “WW company limited” are the attribute values of the “construction company”.

In this case, integrated table data 103 is generated by associating the “equipment name”, “manufacturer”, and “construction company” of the table data 101 with the “device”, “manufacturing company”, and “construction company” of the table data 102, respectively. The integrated table data 103 includes the same attributes as the table data 101, and the attribute values of each of the attributes include the attribute values of both the table data 101 and the table data 102.

A table combining search on open data is known in relation to the table data combining processing. A data integration support device that supports efficient data integration is also known. A database analysis device that enables efficient and highly accurate analysis of a large-scale and complicated database is also known. A data processing device that improves efficiency of work of extracting columns that corresponds to each other between two two-dimensional data is also known.

There are some cases where, in the combining processing of combining two table data, an attribute of one table data is associated with an incorrect attribute of the other table data in the case of associating the attribute of one table data with any attribute of the other table data on the basis of similarity between attributes.

In one aspect, the embodiment aims to accurately associate attributes with each other between two table data.

Hereinafter, embodiments will be described in detail with reference to the drawings.

In the table combining search of F. Nargesian et al., “Table Union Search on Open Data”, Proceedings of the VLDB Endowment, Vol. 11, No. 7, March 2018, pages 813-825, a similarity between attributes is calculated between the two table data, and an attribute of one table data corresponding to each attribute of the other table data is estimated on the basis of the similarity between attributes. As the similarity between attributes, a similarity based on schema matching, a Jaccard similarity, a cosine similarity using a word vector generated by word embedding, a cosine similarity using the vector of Japanese Laid-open Patent Publication No. 2020-112919, or the like can be used in addition to the similarity of F. Nargesian et al., “Table Union Search on Open Data”, Proceedings of the VLDB Endowment, Vol. 11, No. 7, March 2018, pages 813-825.

However, in the case of associating attributes with each other between two table data on the basis of only the similarity between attributes, an attribute B of one table data having the maximum similarity to an attribute A of the other table data is associated with the attribute A. Therefore, an incorrect attribute B may be associated with the attribute A.

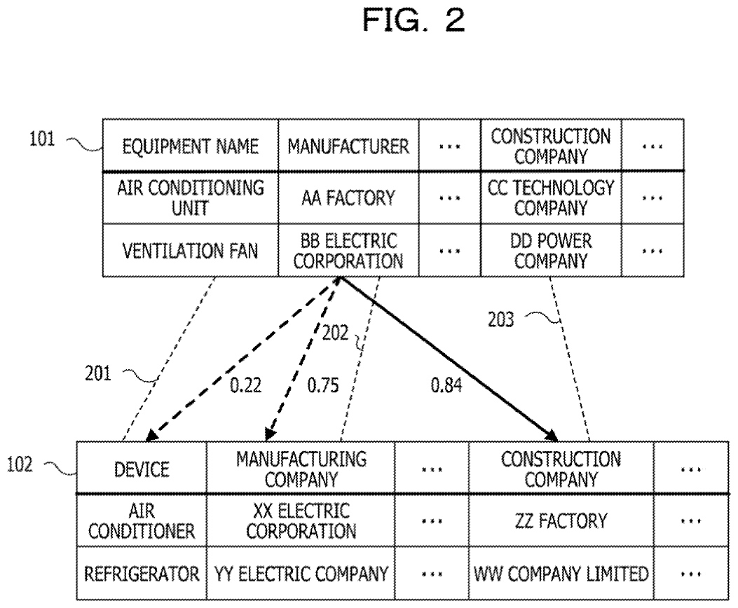

FIG. 2 illustrates an example of incorrect association between two table data. Broken lines 201 to 203 illustrate correct correspondence between the attributes of the table data 101 and the attributes of the table data 102 of FIG. 1. However, when the similarity between attributes is calculated using the attribute value of the “manufacturer” in the table data 101 and the attribute values of the “device”, “manufacturing company”, and “construction company” in table data 102, the following results are obtained.

The similarity of the “manufacturer” and the “device” is 0.22, the similarity of the “manufacturer” and the “manufacturing company” is 0.75, and the similarity of the “manufacturer” and the “construction company” is 0.84.

In this case, the “manufacturer” and the “construction company” indicated by the maximum similarity of 0.84 are incorrectly associated with each other.

In a case where each table data contains a large number of attributes, since the number of combinations of the attributes of one table data and the attributes of the other table data increases, there is a high possibility that an incorrect association is performed.

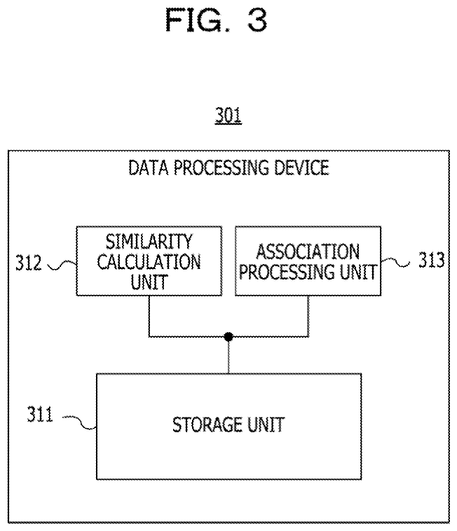

FIG. 3 illustrates a functional configuration example of a data processing device according to the embodiment. A data processing device 301 of FIG. 3 includes a storage unit 311, a similarity calculation unit 312, and an association processing unit 313. The storage unit 311 stores first table data and second table data.

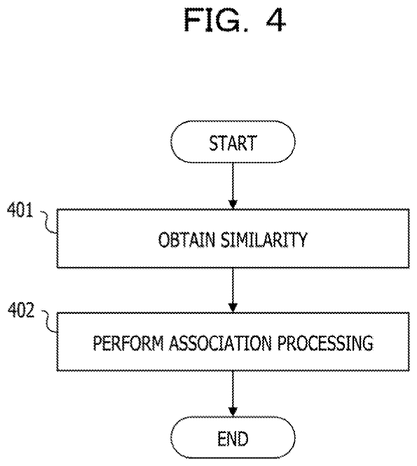

FIG. 4 is a flowchart illustrating an example of data processing performed by the data processing device 301 of FIG. 3. First, the similarity calculation unit 312 obtains a similarity between each of a plurality of attributes included in the first table data and each of a plurality of attributes included in the second table data (step 401).

Next, the association processing unit 313 performs association processing on the basis of the obtained similarity, an order of the plurality of attributes included in the first table data, and an order of the plurality of attributes included in the second table data (step 402). The association processing is processing of associating each of the plurality of attributes included in the first table data with any attribute of the plurality of attributes included in the second table data.

According to the data processing device 301 of FIG. 3, attributes can be accurately associated with each other between two table data.

The attributes included in the table data are often arranged in an order that is easy for humans to understand. In particular, a plurality of highly related attributes is often arranged at positions dose to each other. Therefore, in combining processing of combining two table data, not only the similarity between two association candidate attributes but also the similarity between attributes existing in the vicinity of the association candidate attributes are used, so that the incorrect association is reduced, and the accuracy of the association processing can be improved.

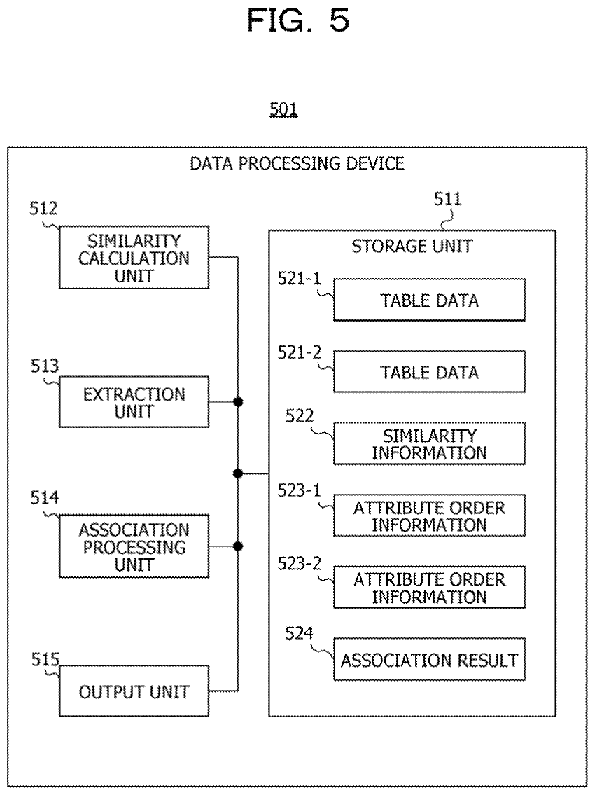

FIG. 5 illustrates a first specific example of the data processing device 301 of FIG. 3. A data processing device 501 of FIG. 5 includes a storage unit 511, a similarity calculation unit 512, an extraction unit 513, an association processing unit 514, and an output unit 515. The storage unit 511, the similarity calculation unit 512, and the association processing unit 514 correspond to the storage unit 311, the similarity calculation unit 312, and the association processing unit 313 of FIG. 3, respectively.

The storage unit 511 stores table data 521-1 and table data 521-2 to be combined. Table data 521-1 and the table data 521-2 include a plurality of attributes and include a plurality of attribute values of each of the attributes.

The similarity calculation unit 512 calculates the similarity between each attribute of the table data 521-1 and each attribute of the table data 521-2, generates similarity information 522 indicating the calculated similarity, and stores the similarity information 522 in the storage unit 511. As the similarity between attributes, for example, the similarity of F. Nargesian et al., “Table Union Search on Open Data”, Proceedings of the VLDB Endowment, Vol. 11, No. 7, March 2018, pages 813-825, the similarity based on schema matching, the Jaccard similarity, the cosine similarity using a word vector, or the cosine similarity using the vector of Japanese Laid-open Patent Publication No. 2020-112919 can be used.

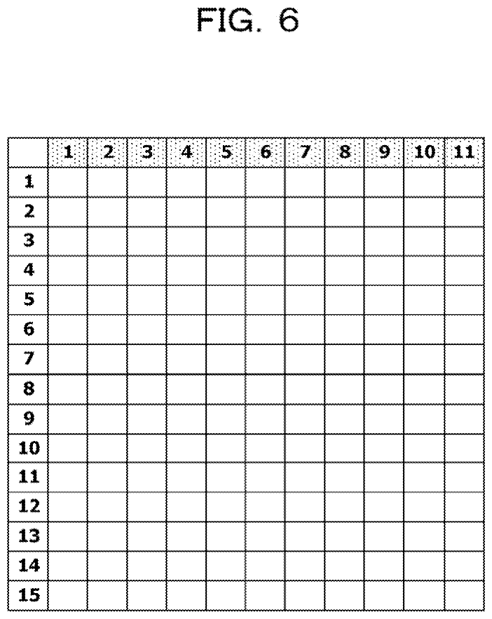

FIG. 6 illustrates an example of the similarity information 522. The similarity information 522 of FIG. 6 is information in a matrix structure, and a row number n (n=1 to 15) indicates the nth attribute of the table data 521-1 and a column number m (m=1 to 11) indicates the mth attribute of the table data 521-2. In this example, the table data 521-1 includes the 1st to 15th attributes, and the table data 521-2 includes the 1st to 11th attributes. In a cell corresponding to the row number n and the column number m, the similarity between the nth attribute of the table data 521-1 and the mth attribute of the table data 521-2 is recorded.

The extraction unit 513 extracts an order of the plurality of attributes in the table data 521-i from the table data 521-i (i=1 or 2), generates attribute order information 523-i indicating the extracted order, and stores the attribute order information 523-i in the storage unit 511.

The association processing unit 514 selects each attribute of the table data 521-1 as an association candidate attribute A1, and selects an attribute B1 adjacent to the attribute A1 in the table data 521-1 using the attribute order information 523-1. Then, the association processing unit 514 selects each attribute of the table data 521-2 as an association candidate attribute A2, and selects an attribute B2 adjacent to the attribute A2 in the table data 521-2 using the attribute order information 523-2.

Next, the association processing unit 514 determines whether to associate the attribute A1 and the attribute A2 on the basis of a similarity SA between the attribute A1 and the attribute A2 and a similarity SB between the attribute B1 and the attribute B2. The association processing unit 514 calculates a similarity S by, for example, the following equation.

S=SA+SB (1)

The similarity S represents a sum of the similarity SA and the similarity SB. The association processing unit 514 calculates the similarity S using each attribute of the table data 521-2 as the attribute A2, and associates the attribute A2 having the maximum similarity S with the attribute A1. By repeating similar processing using each attribute of table data 521-1 as the attribute A1, each attribute of the table data 521-1 is associated with any attribute of the table data 521-2.

Next, the association processing unit 514 generates an association result 524 indicating a correspondence between the plurality of attributes of the table data 521-1 and the plurality of attributes of the table data 521-2, and stores the association result 524 in the storage unit 511. The output unit 515 outputs the association result 524.

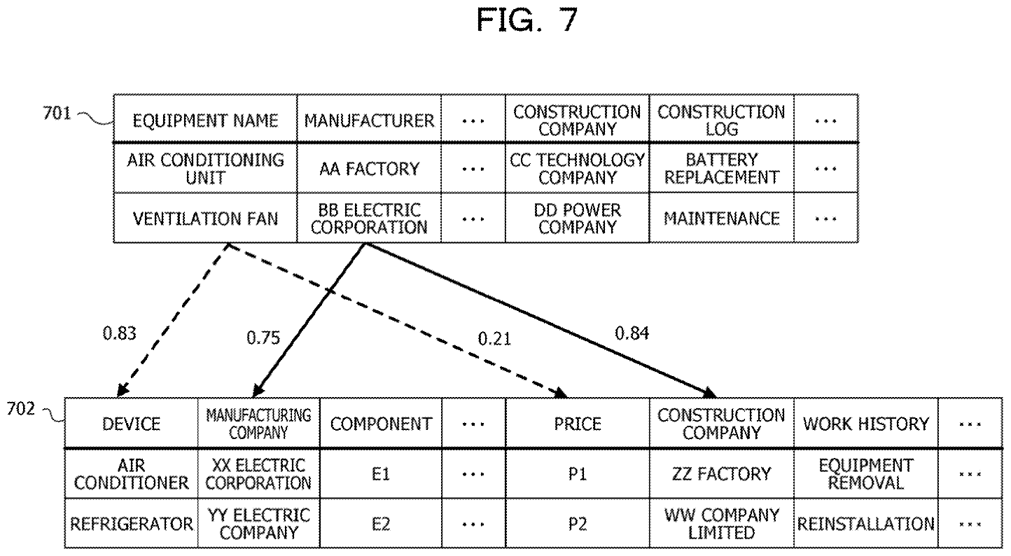

FIG. 7 illustrates an example of association processing using an attribute adjacent to the left side of an association candidate attribute. Table data 701 corresponds to the table data 521-1 of FIG. 5, and includes attributes of the “equipment name”, “manufacturer”, “construction company”, “construction log”, and the like. The “air conditioning unit” and “ventilation fan” are the attribute values of the “equipment name”, and the “AA factory” and “BB electric corporation” are the attribute values of the “manufacturer”. The “CC technology company” and “DD power company” are the attribute values of the “construction company”, and “battery replacement” and“maintenance” are the attribute values of the “construction log”.

Table data 702 corresponds to the table data 521-2 of FIG. 5, and includes attributes of the “device”, “manufacturing company”, “component”, “price”, “construction company”, “work history”, and the like. The “air conditioner” and “refrigerator” are the attribute values of the “device”, and the “XX electric corporation” and “YY electric company” are the attribute values of the “manufacturing company”. “E1” and “E2” are the attribute values of the “component”, and “P1” and “P2” are the attribute values of the “price”. The “ZZ factory” and “WW company limited” are the attribute values of the “construction company”, and “equipment removal” and “reinstallation” are the attribute values of the “work history”.

First, the “manufacturer” of the table data 701 is selected as the attribute A1, and the “equipment name” adjacent to the left side of the “manufacturer” is selected as the attribute B1. Then, the “manufacturing company” in the table data 702 is selected as the attribute A2, and the “device” adjacent to the left side of the “manufacturing company” is selected as the attribute B2. The similarity SA between the “manufacturer” and the “manufacturing company” is 0.75, and the similarity SB between the “equipment name” and the “device” is 0.83; therefore, the similarity S is 1.58.

Next, the “construction company” in the table data 702 is selected as the attribute A2, and the “price” adjacent to the left side of the “construction company” is selected as the attribute B2. The similarity SA between the “manufacturer” and the “construction company” is 0.84, and the similarity SB between the “equipment name” and the “price” is 0.21; therefore, the similarity S is 1.05.

In a case where the similarity S when the “manufacturing company” of the table data 702 is selected as the attribute A2 is the maximum value of the similarity S, the “manufacturer” of the table data 701 is associated with the “manufacturing company”.

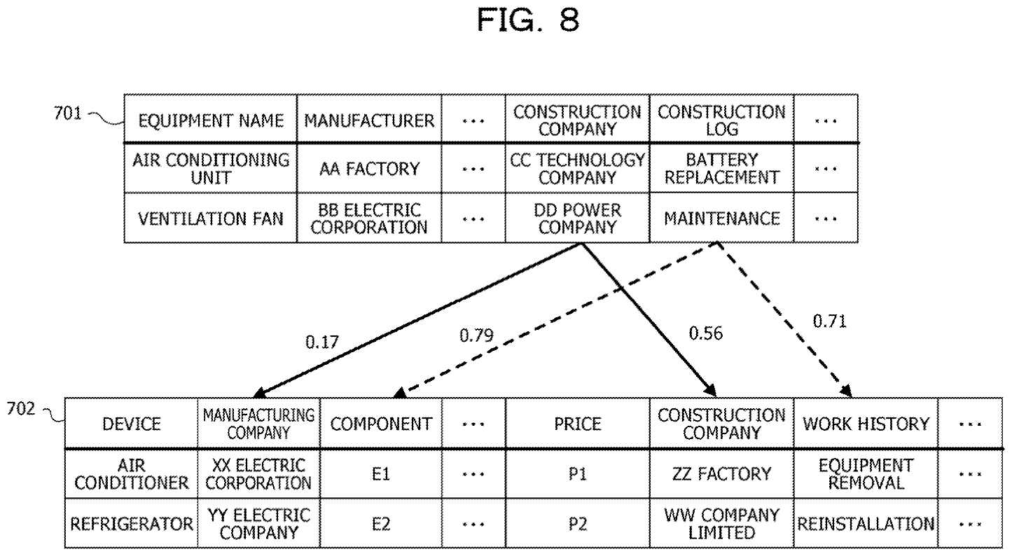

FIG. 8 illustrates an example of the association processing using an attribute adjacent to the right side of an association candidate attribute. First, the “construction company” of the table data 701 is selected as the attribute A1, and the “construction log” adjacent to the right side of the “construction company” is selected as the attribute B1. Then, the “manufacturing company” in the table data 702 is selected as the attribute A2, and the “component” adjacent to the right side of the “manufacturing company” is selected as the attribute B2. The similarity SA between the “construction company” and the “manufacturing company” is 0.17, and the similarity SB between the “construction log” and the “component” is 0.79; therefore, the similarity S is 0.96.

Next, the “construction company” in the table data 702 is selected as the attribute A2, and the “work history” adjacent to the right side of the “construction company” is selected as the attribute B2. The similarity SA between the “construction company” in the table data 701 and the “construction company” in the table data 702 is 0.56, and the similarity SB between the “construction log” and the “work history” is 0.71; therefore, the similarity S is 1.27.

In a case where the similarity S when the “construction company” of the table data 702 is selected as the attribute A2 is the maximum value of the similarity S, the “construction company” of the table data 701 is associated with the “construction company” of the table data 702.

According to such association processing, not only the similarity between two association candidate attributes but also the similarity between attributes adjacent to the association candidate attributes are used, so that the accuracy of the association processing can be improved.

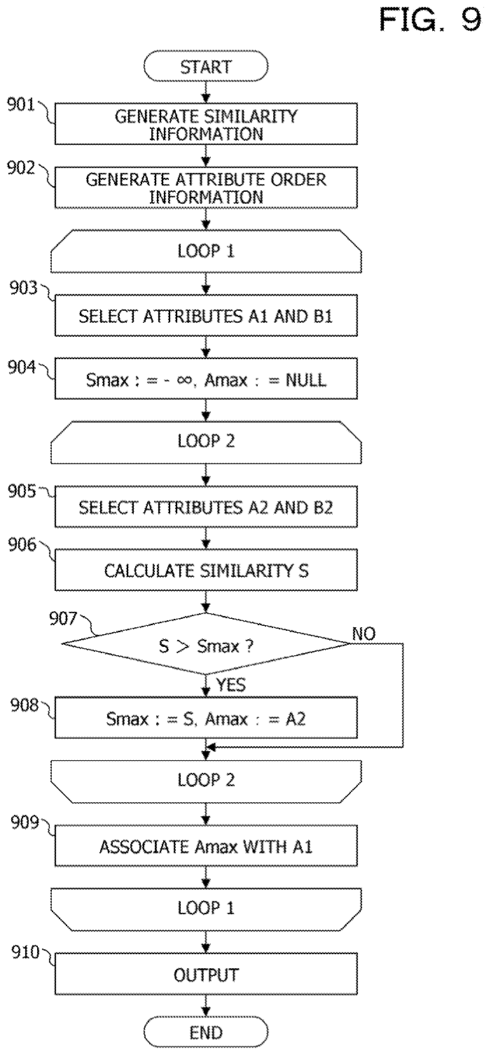

FIG. 9 is a flowchart illustrating an example of first association processing performed by the data processing device 501 of FIG. 5. In the case of using the attribute adjacent to the left side of the association candidate attribute in the first association processing, the left end attributes of the table data 521-1 and the table data 521-2 are excluded from attributes to be processed. In this case, all of attributes other than the left end attributes are the attributes to be processed.

Meanwhile, in the case of using the attribute adjacent to the right side of the association candidate attribute, the right end attributes of the table data 521-1 and the table data 521-2 are excluded from attributes to be processed. In this case, all of attributes other than the right end attributes are the attributes to be processed.

In a case where the table data 521-1 and the table data 521-2 include a large number of attributes, even if the left end or right end attribute is excluded from the attributes to be processed, association for the majority of remaining attributes can be performed.

First, the similarity calculation unit 512 calculates the similarity between each attribute of the table data 521-1 and each attribute of the table data 521-2, and generates the similarity information 522 indicating the calculated similarity (step 901).

Next, the extraction unit 513 generates attribute order information 523-1 indicating the order of the plurality of attributes in the table data 521-1, and generates attribute order information 523-2 indicating the order of the plurality of attributes in the table data 521-2 (step 902).

Next, the association processing unit 514 performs processing of loop 1 for each attribute of the table data 521-1. In the loop 1, the association processing unit 514 selects one of the attributes to be processed included in the table data 521-1 as the association candidate attribute A1 (step 903). Then, the association processing unit 514 identifies the attribute adjacent to the left side or the right side of the attribute A1 in the table data 521-1 by using the attribute order information 523-1 and selects the attribute as the attribute B1.

Next, the association processing unit 514 sets an initial value “−∞” in a variable Smax indicating the maximum value of the similarity S, and sets an initial value “NULL” in a variable Amax indicating an attribute of the table data 521-2 corresponding to the maximum value of the similarity S (step 904). “−∞” represents negative infinity.

Next, the association processing unit 514 performs processing of loop 2 for each attribute of the table data 521-2. In the loop 2, the association processing unit 514 selects one of the attributes to be processed included in the table data 521-2 as the association candidate attribute A2 (step 905). Then, the association processing unit 514 identifies the attribute adjacent to the left side or the right side of the attribute A2 in the table data 521-2 by using the attribute order information 523-2 and selects the attribute as the attribute B2.

In a case where the attribute B1 is adjacent to the left side of the attribute A1, the attribute adjacent to the left side of the attribute A2 is selected as the attribute B2, and in a case where the attribute B1 is adjacent to the right side of the attribute A1, the attribute adjacent to the right side of the attribute A2 is selected as the attribute B2.

Next, the association processing unit 514 calculates the similarity S by the equation (1) (step 906), and compares the similarity S with Smax (step 907). In a case where the similarity S is larger than Smax (step 907, YES), the association processing unit 514 sets the similarity S in Smax and sets the attribute A2 in Amax (step 908). On the other hand, in a case where the similarity S is Smax or less (step 907, NO), the association processing unit 514 does not change Smax and Amax.

When the processing of loop 2 is completed for all the attributes to be processed included in the table data 521-2, the association processing unit 514 associates Amax with the attribute A1 (step 909). When the processing of loop 1 is completed for all the attributes to be processed included in the table data 521-1, the association processing unit 514 generates the association result 524, and the output unit 515 outputs the association result 524 (step 910).

The association processing unit 514 can also perform the association processing by using a plurality of attributes included in a predetermined range based on the attributes of the association candidates. As the plurality of attributes included in the predetermined range, for example, an attribute adjacent to the left side of the association candidate attribute and an attribute adjacent to the right side of the association candidate attribute can be used.

In this case, the association processing unit 514 selects each attribute of the table data 521-1 as the association candidate attribute A1. Then, the association processing unit 514 selects the attribute B1 adjacent to the left side of the attribute A1 and an attribute C1 adjacent to the right side of the attribute A1 in the table data 521-1 using the attribute order information 523-1.

Next, the association processing unit 514 selects each attribute of the table data 521-2 as the association candidate attribute A2. Then, the association processing unit 514 selects the attribute B2 adjacent to the left side of the attribute A2 and an attribute C2 adjacent to the right side of the attribute A2 in the table data 521-2 using the attribute order information 523-2.

Next, the association processing unit 514 calculates the similarity S by the following equation, using the similarity SA between the attribute A1 and the attribute A2, the similarity SB between the attribute B1 and the attribute B2, and a similarity SC between the attribute C1 and the attribute C2.

S=SA+SB+SC (2)

The similarity S represents the sum of the similarity SA, the similarity SB, and the similarity SC. The association processing unit 514 performs the association processing using the similarity S of the equation (2) instead of the similarity S of the equation (1).

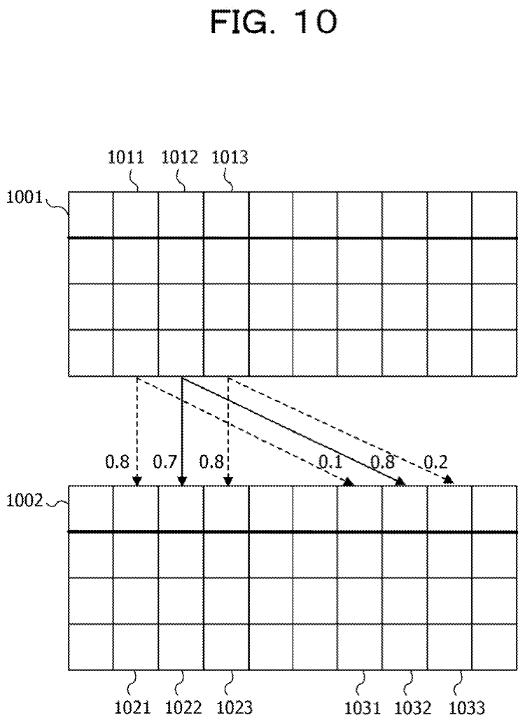

FIG. 10 illustrates an example of the association processing using attributes adjacent to both sides of an association candidate attribute. Table data 1001 corresponds to the table data 521-1 of FIG. 5, and table data 1002 corresponds to the table data 521-2 of FIG. 5.

First, an attribute 1012 of the table data 1001 is selected as the attribute A1, an attribute 1011 adjacent to the left side of the attribute 1012 is selected as the attribute B1, and an attribute 1013 adjacent to the right side of the attribute 1012 is selected as the attribute C1. Then, ab attribute 1022 of the table data 1002 is selected as the attribute A2, an attribute 1021 adjacent to the left side of the attribute 1022 is selected as the attribute B2, and an attribute 1023 adjacent to the right side of the attribute 1022 is selected as the attribute C2.

The similarity SA between the attribute 1012 and the attribute 1022 is 0.7, the similarity SB between the attribute 1011 and the attribute 1021 is 0.8, and the similarity SC between the attribute 1013 and the attribute 1023 is 0.8; therefore, the similarity S is 2.3.

Next, an attribute 1032 of the table data 1002 is selected as the attribute A2, an attribute 1031 adjacent to the left side of the attribute 1032 is selected as the attribute B2, and an attribute 1033 adjacent to the right side of the attribute 1032 is selected as the attribute C2. The similarity SA between the attribute 1012 and the attribute 1032 is 0.8, the similarity SB between the attribute 1011 and the attribute 1031 is 0.1, and the similarity SC between the attribute 1013 and the attribute 1033 is 0.2; therefore, the similarity S is 1.1.

In a case where the similarity S when the attribute 1022 of the table data 1002 is selected as the attribute A2 is the maximum value of the similarity S, the attribute 1012 of the table data 1001 is associated with the attribute 1022.

The association processing unit 514 may use two or more attributes existing on the left side of the association candidate attribute and two or more attributes existing on the right side of the association candidate attribute as the plurality of attributes included in the predetermined range. In this case, the similarity S is calculated by adding the similarity between each attribute included in the predetermined range of the table data 521-1 and each attribute included in the predetermined range of the table data 521-2 to the similarity between two association candidate attributes.

According to such association processing, not only the similarity between two association candidate attributes but also the similarity between attributes included in the predetermined range based on the association candidate attributes are used, so that the accuracy of the association processing can be improved.

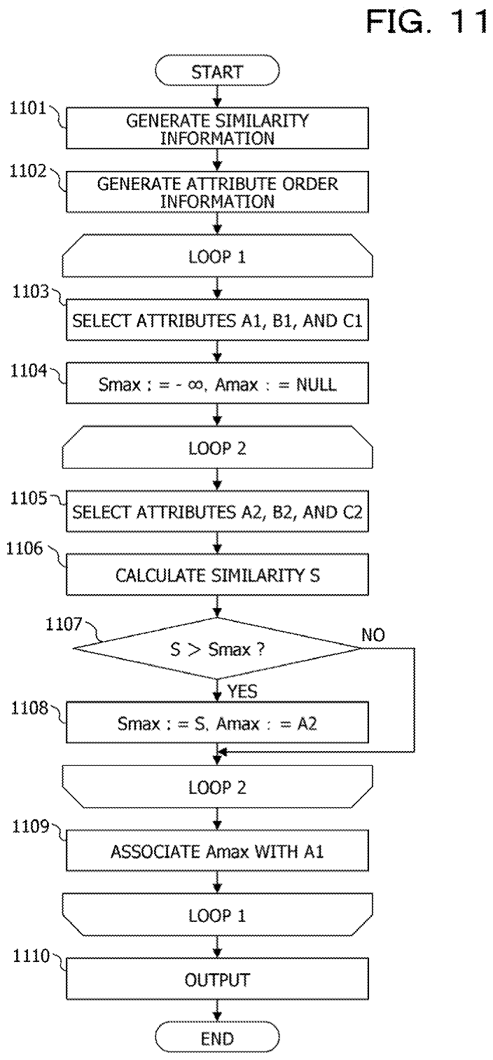

FIG. 11 is a flowchart illustrating an example of second association processing using attributes adjacent to both sides of an association candidate attribute. In the second association processing, the left end and right end attributes of the table data 521-1 and the table data 521-2 are excluded from the attributes to be processed. In this case, all of attributes other than the left end and right end attributes are the attributes to be processed.

In a case where the table data 521-1 and the table data 521-2 include a large number of attributes, even if the left end and right end attributes are excluded from the attributes to be processed, association for the majority of remaining attributes can be performed.

Processing of step 1101, step 1102, step 1104, and steps 1107 to 1110 is similar to the processing of step 901, step 902, step 904, and steps 907 to 910 of FIG. 9.

In step 1103, the association processing unit 514 selects one of the attributes to be processed included in the table data 521-1 as the association candidate attribute A1. Then, the association processing unit 514 identifies the attribute adjacent to the left side of the attribute A1 in the table data 521-1 by using the attribute order information 523-1 and selects the attribute as the attribute B1. Furthermore, the association processing unit 514 identifies the attribute adjacent to the right side of the attribute A1 in the table data 521-1 by using the attribute order information 523-1 and selects the attribute as the attribute C1.

In step 1105, the association processing unit 514 selects one of the attributes to be processed included in the table data 521-2 as the association candidate attribute A2. Then, the association processing unit 514 identifies the attribute adjacent to the left side of the attribute A2 in the table data 521-2 by using the attribute order information 523-2 and selects the attribute as the attribute B2. Furthermore, the association processing unit 514 identifies the attribute adjacent to the right side of the attribute A2 in the table data 521-2 by using the attribute order information 523-2 and selects the attribute as the attribute C2.

In step 1106, the association processing unit 514 calculates the similarity S by the equation (2).

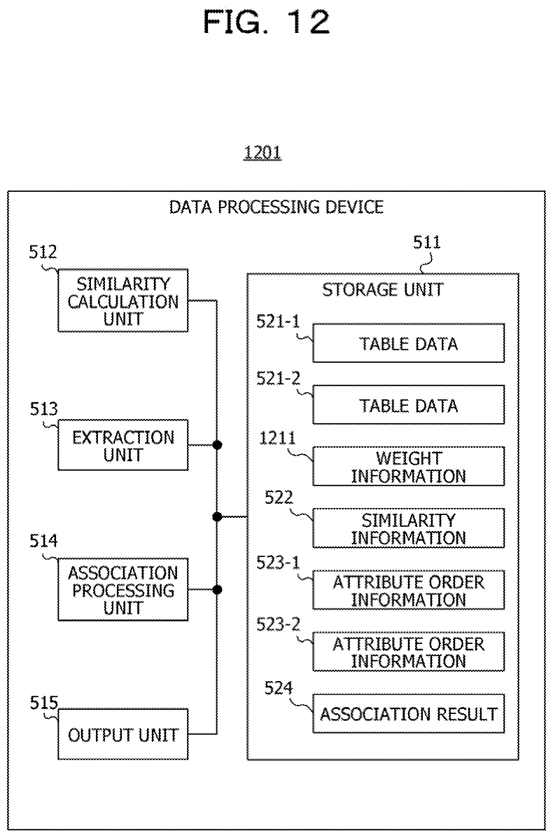

FIG. 12 illustrates a second specific example of the data processing device 301 of FIG. 3. A data processing device 1201 of FIG. 12 has a similar configuration to the data processing device 501 of FIG. 5. The storage unit 511 further stores weight information 1211. The weight information 1211 includes a weighting coefficient for each of the plurality of similarities used in the calculation of the similarity S. The association processing unit 514 calculates a weighted sum of the plurality of similarities using the weighting coefficients included in the weight information 1211, and performs the association processing using the weighted sum as the similarity S.

For example, in the case of using the similarity SA, the similarity SB, and the similarity SC of the equation (2) as the plurality of similarities, the association processing unit 514 calculates the similarity S by the following equation.

S=WA*SA+WB*SB +WC*SC (3)

WA, WB, and WC respectively represent the weighting coefficients for the similarity SA, similarity SB, and similarity SC, and the similarity S represents the weighted sum of the similarity SA, similarity SB, and similarity SC. The association processing unit 514 performs the association processing using the similarity S of the equation (3) instead of the similarity S of the equation (2).

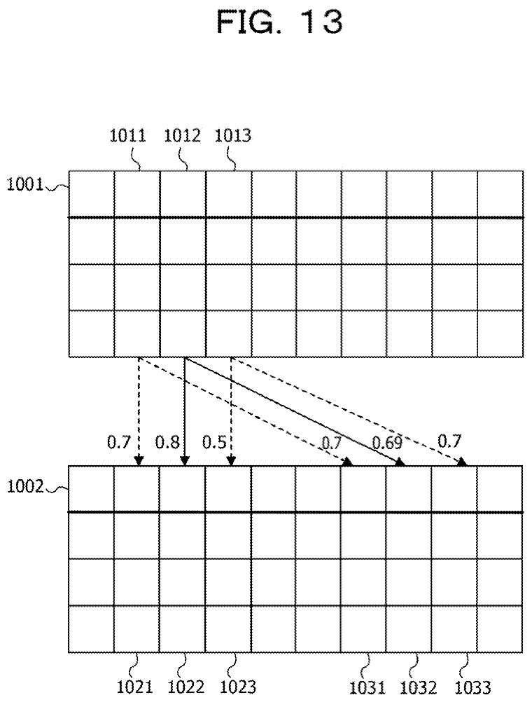

FIG. 13 illustrates an example of the association processing using the weight information 1211 with respect to the table data 1001 and the table data 1002 of FIG. 10. First, weighting is performed with WA=1.0, WB=1.0, and WC=1.0. In this example, since the similarity SA between the attribute 1012 and the attribute 1022 is 0.8, the similarity SB between the attribute 1011 and the attribute 1021 is 0.7, and the similarity SC between the attribute 1013 and the attribute 1023 is 0.5, the sum is 2.0.

Furthermore, since the similarity SA between the attribute 1012 and the attribute 1032 is 0.69, the similarity SB between the attribute 1011 and the attribute 1031 is 0.7, and the similarity SC between the attribute 1013 and the attribute 1033 is 0.7, the sum is 2.09. Therefore, in the case of using the sum as the similarity S, the attribute 1012 of the table data 1001 is associated with the attribute 1032.

Meanwhile, by using the similarity S in the equation (3), the weighting in which the weight of the similarity SA is larger than the weights of the similarity SB and the similarity SC can be performed. For example, in the case of performing the weighting with WA=1.0, WB=0.5, and WC=0.5, the similarity S between the attribute 1012 and the attribute 1022 is calculated by the following equation.

S=1.0*0.8+0.5*0.7+0.5*0.5=1.4 (4)

Similarly, the similarity S between the attribute 1012 and the attribute 1032 is calculated by the following equation.

S=1.0*0.69+0.5*0.7+0.5*0.7=1.39 (5)

In this case, since the similarity S of the equation (4) is larger than the similarity S of the equation (5), the attribute 1012 of the table data 1001 is associated with the attribute 1022.

According to such association processing, the similarity between two association candidate attributes can be more preferentially used than the similarity between attributes included in the predetermined range based on the two association candidate attributes.

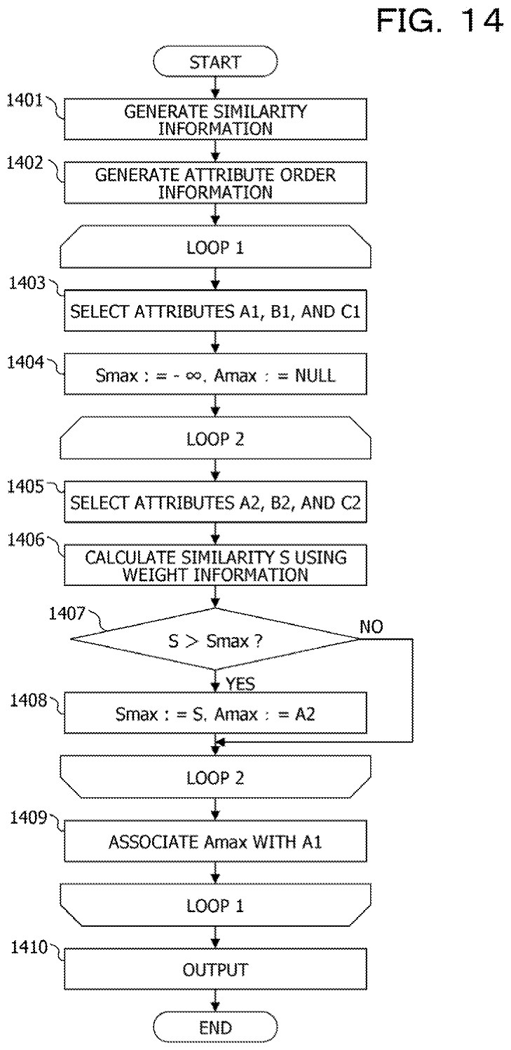

FIG. 14 is a flowchart illustrating an example of third association processing using the weight information 1211. Processing of steps 1401 to 1405 and steps 1407 to 1410 is similar to the processing of steps 1101 to 1105 and steps 1107 to 1110 of FIG. 11. In step 1406, the association processing unit 514 calculates the similarity S by the equation (3).

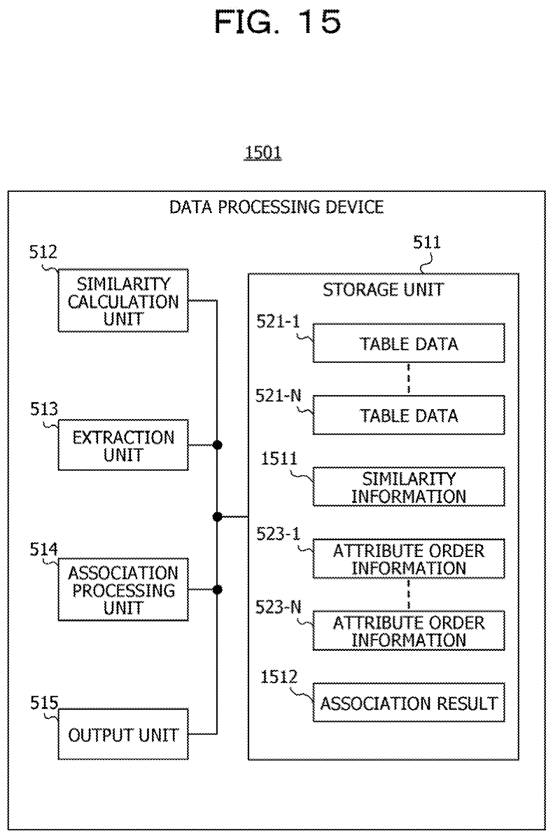

FIG. 15 illustrates a third specific example of the data processing device 301 of FIG. 3. A data processing device 1501 of FIG. 15 has a similar configuration to the data processing device 501 of FIG. 5. The storage unit 511 stores the table data 521-1 to table data 521-N (N is an integer of 3 or more).

The similarity calculation unit 512 calculates the similarity between each attribute of the table data 521-1 and each attribute of the table data 521-i (i=2 to N), generates similarity information 1511 indicating the calculated similarity, and stores the similarity information 1511 in the storage unit 511.

The extraction unit 513 extracts the order of the plurality of attributes in the table data 521-i from the table data 521-i (i=1 to N), generates the attribute order information 523-i indicating the extracted order, and stores the attribute order information 523-i in the storage unit 511.

The association processing unit 514 associates each attribute of the table data 521-1 with any attribute of the table data 521-i (i=2 to N), using the similarity information 1511 and the attribute order information 523-1 to attribute order information 523-N. Then, the association processing unit 514 generates an association result 1512 indicating a correspondence between the plurality of attributes of the table data 521-1 and the plurality of attributes of the table data 521-i (i=2 to N), and stores the association result 1512 in the storage unit 511. The output unit 515 outputs the association result 1512.

According to the data processing device 1501 of FIG. 15, even when three or more table data exist, the attributes included in the three or more table data can be accurately associated with each other.

The configurations of the data processing device 301 of FIG. 3, the data processing device 501 of FIG. 5, the data processing device 1201 of FIG. 12, and the data processing device 1501 of FIG. 15 are merely examples, and some configuration elements may be omitted or changed according to the use or conditions of the data processing device. For example, in the data processing device 501, the data processing device 1201, and the data processing device 1501, in a case where the attribute order information 523-i is stored in the storage unit 511 in advance, the extraction unit 513 can be omitted.

The flowcharts illustrated in FIGS. 4, 9, 11, and 14 are merely examples and some processing may be omitted or modified according to the configuration or conditions of the data processing device. For example, in the data processing device 501 and the data processing device 1201, in a case where the attribute order information 523-i is stored in the storage unit 511 in advance, the processing of steps 902, 1102, and 1402 can be omitted.

The table data illustrated in FIGS. 1, 2, 7, and 8 are merely examples, and the table data changes according to the use or conditions of the data processing device. The similarity information illustrated in FIG. 6 is merely an example, and the number of calculated similarities changes according to the number of attributes included in the table data. The similarities illustrated in FIGS. 10 and 13 are merely examples, and the similarity changes according to the table data.

Equations (1) to (5) are merely examples, and the data processing device may calculate the similarity using another calculation equation.

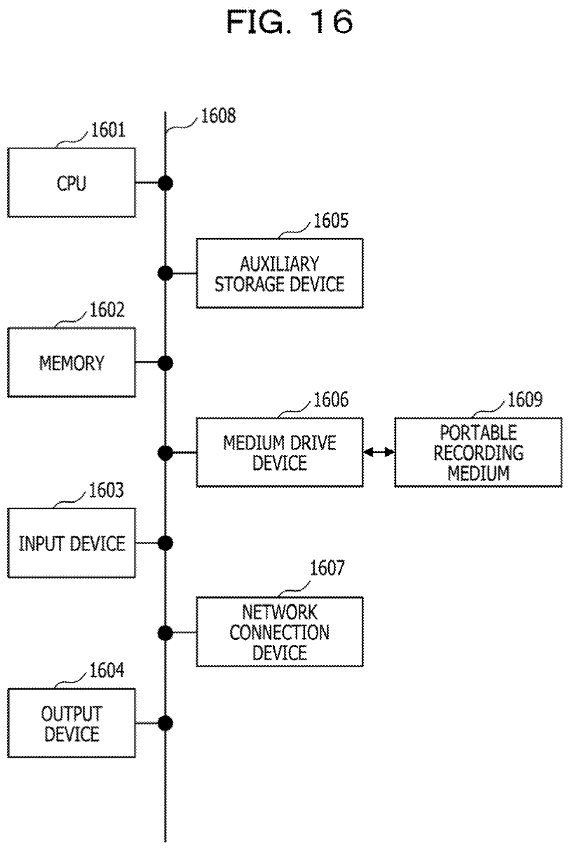

FIG. 16 illustrates a hardware configuration example of an information processing device (computer) used as the data processing device 301 of FIG. 3, the data processing device 501 of FIG. 5, the data processing device 1201 of FIG. 12, or the data processing device 1501 of FIG. 15. The information processing device in FIG. 16 includes a central processing unit (CPU) 1601, a memory 1602, an input device 1603, an output device 1604, an auxiliary storage device 1605, a medium drive device 1606, and a network connection device 1607. These configuration elements are hardware and are connected to each other by a bus 1608.

The memory 1602 is a semiconductor memory, for example, a read only memory (ROM), a random access memory (RAM), a flash memory, and the like, and stores a program and data used for processing. The memory 1602 may operate as the storage unit 311 of FIG. 3 or the storage unit 511 of FIG. 5, 12, or 15.

The CPU 1601 (processor) operates as the similarity calculation unit 312 and the association processing unit 313 in FIG. 3 by, for example, executing the program using the memory 1602. The CPU 1601 also operates as the similarity calculation unit 512, the extraction unit 513, and the association processing unit 514 of FIG. 5, 12, or 15 by executing a program using the memory 1602.

The input device 1603 is, for example, a keyboard, a pointing device, or the like and is used for inputting an instruction or information from an operator or a user. The output device 1604 is, for example, a display device, a printer, or the like and is used for an inquiry or an instruction to the operator or the user, and outputting a processing result. The processing result may be the association result 524 or the association result 1512. The output device 1604 may operate as the output unit 515 of FIG. 5, 12, or 15.

The auxiliary storage device 1605 is, for example, a magnetic disk device, an optical disk device, a magneto-optical disk device, a tape device, or the like. The auxiliary storage device 1605 may be a hard disk drive or a flash memory. The information processing device can save programs and data in the auxiliary storage device 1605 and load these programs and data into the memory 1602 to use. The auxiliary storage device 1605 may operate as the storage unit 311 of FIG. 3 or the storage unit 511 of FIG. 5, 12, or 15.

The medium drive device 1606 drives a portable recording medium 1609 and accesses recorded content of the portable recording medium 1609. The portable recording medium 1609 is a memory device, a flexible disk, an optical disk, a magneto-optical disk, or the like. The portable recording medium 1609 may be a compact disk read only memory (CD-ROM), a digital versatile disk (DVD), a universal serial bus (USB) memory, or the like. The operator or the user can store programs and data in the portable recording medium 1609 and load these programs and data into the memory 1602 for use.

As described above, a computer-readable recording medium in which the programs and data used for processing are stored includes a physical (non-transitory) recording medium such as the memory 1602, the auxiliary storage device 1605, and the portable recording medium 1609.

The network connection device 1607 is a communication interface circuit that is connected to a communication network such as a local area network (LAN) and a wide area network (WAN), and that performs data conversion pertaining to communication. The information processing device can receive programs and data from an external device via the network connection device 1607 and load these programs and data into the memory 1602 to use. The network connection device 1607 may operate as the output unit 515 of FIGS. 5, 12, and 15.

Note that the information processing device does not need to include all the configuration elements in FIG. 16, and some configuration elements may be omitted according to the use or conditions of the information processing device. For example, in a case where an interface with the operator or the user is not needed, the input device 1603 and the output device 1604 may be omitted. In a case where the portable recording medium 1609 or the communication network is not used, the medium drive device 1606 or the network connection device 1607 may be omitted.

While the disclosed embodiments and the advantages thereof have been described in detail, those skilled in the art will be able to make various modifications, additions, and omissions without departing from the scope of the embodiments as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data processing program for causing a computer to execute processing comprising:
obtaining a similarity between each of a plurality of attributes included in first table data and each of a plurality of attributes included in second table data; and
associating each of the plurality of attributes included in the first table data with any attribute of the plurality of attributes included in the second table data on the basis of the similarity, an order of the plurality of attributes included in the first table data, and an order of the plurality of attributes included in the second table data.

2. The non-transitory computer-readable recording medium storing a data processing program according to claim 1, wherein the processing of associating each of the plurality of attributes included in the first table data with any attribute of the plurality of attributes included in the second table data includes processing of selecting a first attribute and a second attribute adjacent to the first attribute from among the plurality of attributes included in the first table data on the basis of the order of the plurality of attributes included in the first table data, processing of selecting a third attribute and a fourth attribute adjacent to the third attribute from among the plurality of attributes included in the second table data on the basis of the order of the plurality of attributes included in the second table data, and processing of associating the first attribute with the third attribute on the basis of the similarity between the first attribute and the third attribute and the similarity between the second attribute and the fourth attribute.

3. The non-transitory computer-readable recording medium storing a data processing program according to claim 1, wherein the processing of associating each of the plurality of attributes included in the first table data with any attribute of the plurality of attributes included in the second table data includes processing of selecting a first attribute and a plurality of attributes included in a predetermined range based on the first attribute from among the plurality of attributes included in the first table data on the basis of the order of the plurality of attributes included in the first table data, processing of selecting a second attribute and a plurality of attributes included in a predetermined range based on the second attribute from among the plurality of attributes included in the second table data on the basis of the order of the plurality of attributes included in the second table data, and processing of associating the first attribute with the second attribute on the basis of the similarity between the first attribute and the second attribute and the similarity between each of the plurality of attributes included in the predetermined range based on the first attribute and each of the plurality of attributes included in the predetermined range based on the second attribute.

4. The non-transitory computer-readable recording medium storing a data processing program according to claim 1, for causing the computer to further execute processing comprising:
obtaining a similarity between each of the plurality of attributes included in the first table data and each of a plurality of attributes included in third table data; and
associating each of the plurality of attributes included in the first table data with any attribute of the plurality of attributes included in the third table data on the basis of the similarity between each of the plurality of attributes included in the first table data and each of the plurality of attributes included in the third table data, the order of the plurality of attributes included in the first table data, and an order of the plurality of attributes included in the third table data.

5. A data processing device comprising:
a memory; and
a processor coupled to the memory and configured to:
obtain a similarity between each of a plurality of attributes included in first table data and each of a plurality of attributes included in second table data; and
associate each of the plurality of attributes included in the first table data with any attribute of the plurality of attributes included in the second table data on the basis of the similarity, an order of the plurality of attributes included in the first table data, and an order of the plurality of attributes included in the second table data.

6. The data processing device according to claim 5, wherein the processing of associating each of the plurality of attributes included in the first table data with any attribute of the plurality of attributes included in the second table data includes processing of selecting a first attribute and a second attribute adjacent to the first attribute from among the plurality of attributes included in the first table data on the basis of the order of the plurality of attributes included in the first table data, processing of selecting a third attribute and a fourth attribute adjacent to the third attribute from among the plurality of attributes included in the second table data on the basis of the order of the plurality of attributes included in the second table data, and processing of associating the first attribute with the third attribute on the basis of the similarity between the first attribute and the third attribute and the similarity between the second attribute and the fourth attribute.

7. The data processing device according to claim 5, wherein the processing of associating each of the plurality of attributes included in the first table data with any attribute of the plurality of attributes included in the second table data includes processing of selecting a first attribute and a plurality of attributes included in a predetermined range based on the first attribute from among the plurality of attributes included in the first table data on the basis of the order of the plurality of attributes included in the first table data, processing of selecting a second attribute and a plurality of attributes included in a predetermined range based on the second attribute from among the plurality of attributes included in the second table data on the basis of the order of the plurality of attributes included in the second table data, and processing of associating the first attribute with the second attribute on the basis of the similarity between the first attribute and the second attribute and the similarity between each of the plurality of attributes included in the predetermined range based on the first attribute and each of the plurality of attributes included in the predetermined range based on the second attribute.

8. The data processing device according to claim 5, wherein the processor:
obtains a similarity between each of the plurality of attributes included in the first table data and each of a plurality of attributes included in third table data; and
associates each of the plurality of attributes included in the first table data with any attribute of the plurality of attributes included in the third table data on the basis of the similarity between each of the plurality of attributes included in the first table data and each of the plurality of attributes included in the third table data, the order of the plurality of attributes included in the first table data, and an order of the plurality of attributes included in the third table data.

9. A data processing method comprising;
obtaining, by a computer, a similarity between each of a plurality of attributes included in first table data and each of a plurality of attributes included in second table data; and
associating each of the plurality of attributes included in the first table data with any attribute of the plurality of attributes included in the second table data on the basis of the similarity, an order of the plurality of attributes included in the first table data, and an order of the plurality of attributes included in the second table data.

10. The data processing method according to claim 9, wherein the processing of associating each of the plurality of attributes included in the first table data with any attribute of the plurality of attributes included in the second table data includes processing of selecting a first attribute and a second attribute adjacent to the first attribute from among the plurality of attributes included in the first table data on the basis of the order of the plurality of attributes included in the first table data, processing of selecting a third attribute and a fourth attribute adjacent to the third attribute from among the plurality of attributes included in the second table data on the basis of the order of the plurality of attributes included in the second table data, and processing of associating the first attribute with the third attribute on the basis of the similarity between the first attribute and the third attribute and the similarity between the second attribute and the fourth attribute.

11. The data processing method according to claim 9, wherein the processing of associating each of the plurality of attributes included in the first table data with any attribute of the plurality of attributes included in the second table data includes processing of selecting a first attribute and a plurality of attributes included in a predetermined range based on the first attribute from among the plurality of attributes included in the first table data on the basis of the order of the plurality of attributes included in the first table data, processing of selecting a second attribute and a plurality of attributes included in a predetermined range based on the second attribute from among the plurality of attributes included in the second table data on the basis of the order of the plurality of attributes included in the second table data, and processing of associating the first attribute with the second attribute on the basis of the similarity between the first attribute and the second attribute and the similarity between each of the plurality of attributes included in the predetermined range based on the first attribute and each of the plurality of attributes included in the predetermined range based on the second attribute.

12. The data processing method according to claim further comprising:
obtaining a similarity between each of the plurality of attributes included in the first table data and each of a plurality of attributes included in third table data; and
associating each of the plurality of attributes included in the first table data with any attribute of the plurality of attributes included in the third table data on the basis of the similarity between each of the plurality of attributes included in the first table data and each of the plurality of attributes included in the third table data, the order of the plurality of attributes included in the first table data, and an order of the plurality of attributes included in the third table data.
